(19) United States
(12) Patent Application Publication
(10) Pub. No.: US 2006/0063411 A1
(43) Pub. Date: Mar. 23, 2006

(54) Floating power connector mount for a power converter

(75) Inventors: Minchul Kim, The Colony, TX (US); Joanne Zhang, Plano, TX (US)

Correspondence Address: HITT GAINES P.C., P.O. BOX 832570, RICHARDSON, TX, 75083, US

(73) Assignee: Tyco Electronics Power Systems, Inc., A Nevada Corporation, Mesquite, TX (US)

(21) Appl. No.: 10/948,530

(22) Filed: Sep. 23, 2004

(51) Int. Cl. H01R 13/64

(52) U.S. Cl. 439/247

(57) ABSTRACT

For use with a power converter shelf having a rear wall, a floating power connector mount and a power converter rack incorporating the power connector mount. In one embodiment, the power connector mount includes a float housing having a recess therein configured to receive and capture a flange of a standards-based power connector between the float housing and the rear wall, the standards-based power connector enabled to float or move freely within the recess.

### TECHNICAL FIELD OF THE INVENTION

The present invention is directed, in general, to power converter racks for modular power converters and, more specifically, to a floating power connector mount for a power converter rack.

### BACKGROUND OF THE INVENTION

People have come to expect that their telephones will operate all the time, even during a power blackout. However, this degree of reliability does not magically happen. Every central office (CO) in the public switched telephone network (PSTN) is provided with an emergency power source in case primary power is lost or unusable. The emergency power source employs “strings” of batteries to store the emergency power. Power converters coupled to the battery strings use primary power to charge the batteries during normal operation and draw power from the batteries as needed.

A power converter is a device used to convert electrical energy from one form to another (e.g., converting an alternating current (AC) to direct current (DC), or vice versa, or to transform an AC or DC voltage to a different level). Typically, each power converter module has its own input requirements and output capabilities. Multiple power converters are mounted in one or more power converter racks in a conventional emergency power source; the power converter racks provide the interconnections necessary to allow the converters to operate together to charge.

A typical power converter rack therefore has a “backplane” that includes a power outlet to couple a module inserted into the rack to a source of AC power. Each power outlet includes power terminals (“hot” and “neutral”) and a ground terminal. Conventional rack-mount modules are constructed so they can be easily inserted into a bay in the power converter rack. To facilitate quick installation, power converter modules have a conventional AC power plug, positioned at the rear of the module, that engages an AC power outlet in the backplane as the module is inserted. In many such racks and modules, the power plug and power outlet conform to International Electrotechnical Commission (IEC) standards.

Some leeway space must exist between the module and the bay into which it is inserted to keep module insertion and extraction force to a reasonable level and to allow for dimensional deviations in the module and the bay. Unfortunately, the leeway space introduces the possibility of misalignment as the AC power plug with respect to the AC power outlet. If the misalignment becomes too great, the plug will not mate with the outlet, and the module will not be able to seat and operate. It is therefore desirable to ensure that the plug and outlet mate even when misalignment is at its maximum.

Rack depth is also an important concern because racks occupy valuable CO floor space; the less floor space required, the better. While power converter module depths are under constant scrutiny, the depth of the backplane is also the subject of attention. It is therefore desirable to decrease the depth of the backplane and thereby the overall depth of the power converter rack.

As stated above, power converters typically have different input requirements and output capabilities. This is so even if the modules in which the power converters are housed have the same outer dimensions. It is therefore desirable to prevent power converters that are incompatible with a particular bay from being successfully installed in that bay.

Accordingly, what is needed in the art is a power converter rack design that reliably accommodates plug and outlet misalignments. What is further needed in the art is a power converter rack design that results in a backplane of diminished depth. What is still further needed in the art is a better way to discriminate among the various types of power converter module so as to prevent incompatible power converter module types from being installed in inappropriate bays. What is yet further needed in the art is a power converter rack design that is more straightforward to manufacture and allows fewer manufacturing errors.

### SUMMARY OF THE INVENTION

To address the above-discussed deficiencies of the prior art, the present invention provides, in one aspect, a “floating” power connector mount. In one embodiment, the power connector mount includes a float housing having a recess therein configured to receive and capture a flange of a standards-based power connector between the float housing and a rear wall of a power converter shelf, the standards-based power connector enabled to float or move freely within the recess.

In yet another aspect, the present invention provides a power converter rack. In one embodiment, the power converter rack includes: (1) a power converter shelf having a rear wall and divided into a plurality of bays and (2) a floating power connector mount associated with each of the plurality of bays, the floating power connector mount including a float housing having a recess therein that receives and captures a flange of a standards-based power connector between the float housing and the rear wall, the standards-based power connector enabled to float or move freely within the recess.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates an isometric view of one embodiment of a power converter rack constructed according to the principles of the present invention;

FIG. 2 illustrates a partial, assembled, isometric view of a power converter shelf employable within the power converter rack of FIG. 1 and constructed according to the principles of the present invention;

FIG. 3 illustrates an exploded, isometric view of a portion of the power converter shelf of FIG. 2;

FIG. 4 illustrates a reverse-angle, exploded, isometric view of the power converter shelf of FIGS. 2 and 3; and

FIG. 5 illustrates a reverse-angle, assembled, isometric view of the power converter shelf of FIGS. 2, 3 and 4.

### DETAILED DESCRIPTION

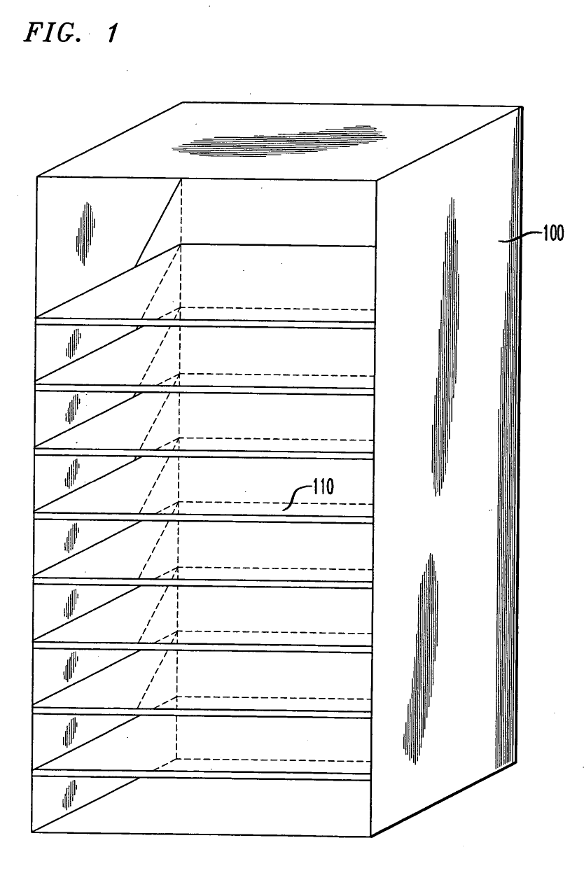

Referring initially to FIG. 1, illustrated is an isometric view of one embodiment of a power converter rack constructed according to the principles of the present invention.

The illustrated embodiment of the power converter rack includes a cabinet 100. The cabinet 100 may be of any form or construction and serves primarily to support and protect various power converter shelves located therein.

One of the power converter shelves is referenced as 110. The power converter shelf 110 is mountable within the cabinet 100. The power converter shelf 110 has a rear wall and divided into a plurality of bays (not shown in FIG. 1 due to scale). Having shown the power converter rack in general, the power converter shelf will now be detailed.

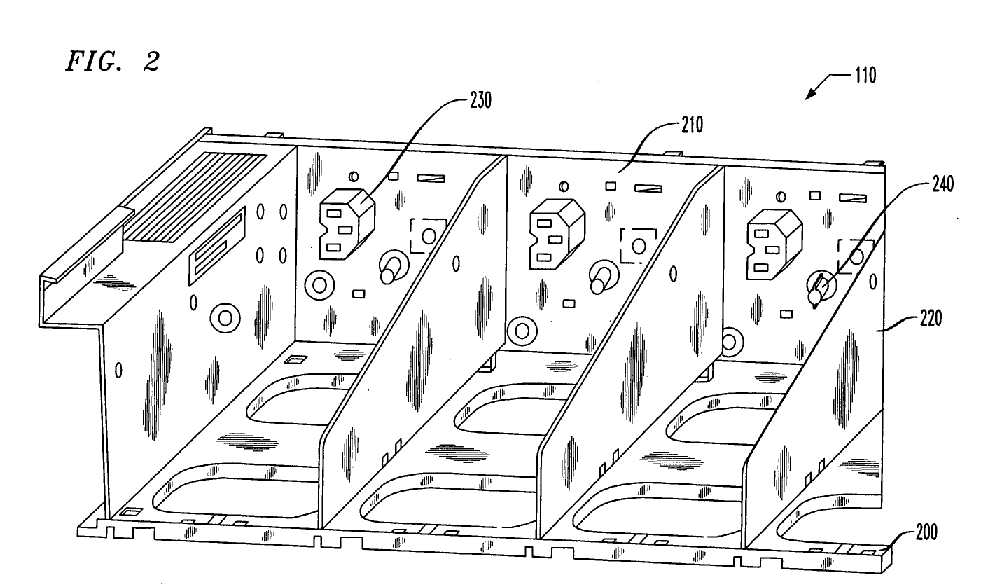

Accordingly, turning now to FIG. 2, illustrated is a partial, assembled, isometric view of a power converter shelf 110 employable within the power converter rack of FIG. 1 and constructed according to the principles of the present invention.

The power converter shelf 110 has a base 200, a rear wall 210 and a plurality of dividers 220 that define bays for power converters on the power converter shelf 110. Each bay has a standards-based power connector 230 (an IEC power outlet in the illustrated embodiment). As set forth above, some leeway exists in the dimensions of each bay such that power converter modules may be inserted or extracted without undue frictional resistance. Accordingly, some misalignment may be present as a module is inserted into the bay and corresponding plugs and outlets come into contact. The present invention provides an improved way to allow the standards-based power connector to “float” (move) to some extent such that the misalignment can be compensated for. The manner in which the power connector moves will be explained in conjunction with the FIGUREs that follow.

Each bay also has a keying boss 240. As set forth above, even though they may be contained in modules of the same size and shape, power converters often have different input voltage and output power specifications. While optional, the keying boss 240 advantageously allows only modules of the proper type to mate with the standards-based power connector 230 (and other backplane interconnections which are not referenced). In the illustrated embodiment, the keying boss 240 is coupled to the float housing and is configured to extend through a keying aperture in the rear wall 210. The keying boss 240 also has lateral extensions, or “wings” (not separately referenced in FIG. 2), that are oriented to form a key that defines a type of module allowed to be coupled to the standards-based power connector.

In the illustrated embodiment, the lateral extensions define keys like the hands on a clock. For example, the lateral extensions may be oriented at 9 and 3 o'clock to define a power converter of a first type, or at 12 and 6 o'clock to define a power converter of a second type. The lateral extensions may be at 12 and 3 o'clock to define a power converter of a third type. Those skilled in the art will readily see that many different combinations of lateral extension orientation are possible. Thus, the lateral extensions provide a flexible and powerful way to define a wide variety of power converter types.

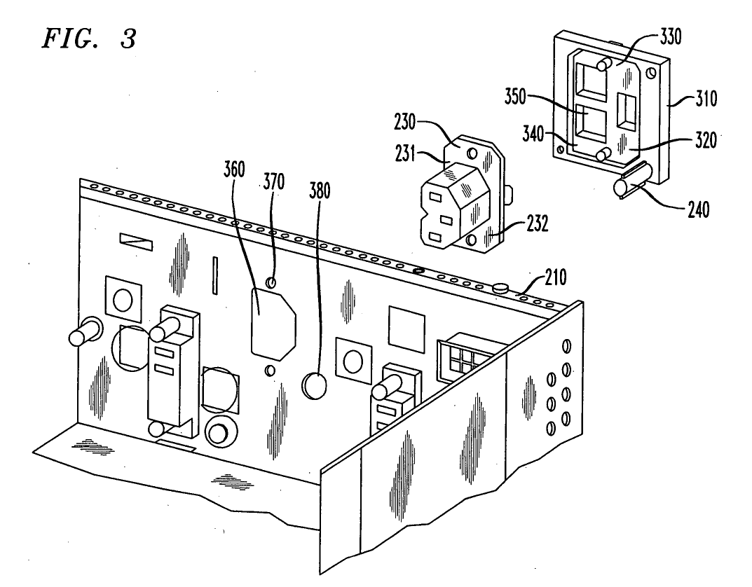

Turning now to FIG. 3, illustrated is an exploded, isometric view of a portion of the power converter shelf of FIG. 2. FIG. 3 illustrates a float housing 310. The float housing 310 has a recess 320 therein. The recess 320 is configured to receive and capture a flange 231 of the standards-based power connector 230 between the float housing 310 and the rear wall 210 when the float housing 310 is coupled to the rear wall 210.

In the illustrated embodiment, the floating power connector mount further includes a mounting post 330 coupled to the float housing 310. In fact, FIG. 3 shows two such mounting posts. The mounting post 330 is configured (1) in position to fit within a corresponding mounting hole 232 of the standards-based power connector 230 and (2) in lateral dimension to enable the standards-based power connector 230 to “float” freely within the recess 320 a predetermined amount, constrained by the size of the mounting post 330 relative to the mounting hole 232.

The shape of the recess 320 is defined, in part, by its lateral dimensions 340. In the illustrated embodiment, the shape of the recess 320 is similar (in the geometric sense) to the shape of the flange 231. The size, however, of the recess 320 is slightly larger than that of the flange 231. This size difference allows the flange 231 and therefore the standards-based power connector 230 to float laterally relative to the float housing 310 and therefore relative to the rear wall 210. However, the standards-based power connector 230 can float within the recess a predetermined amount, constrained by the size of the recess 320 relative to the flange 231.

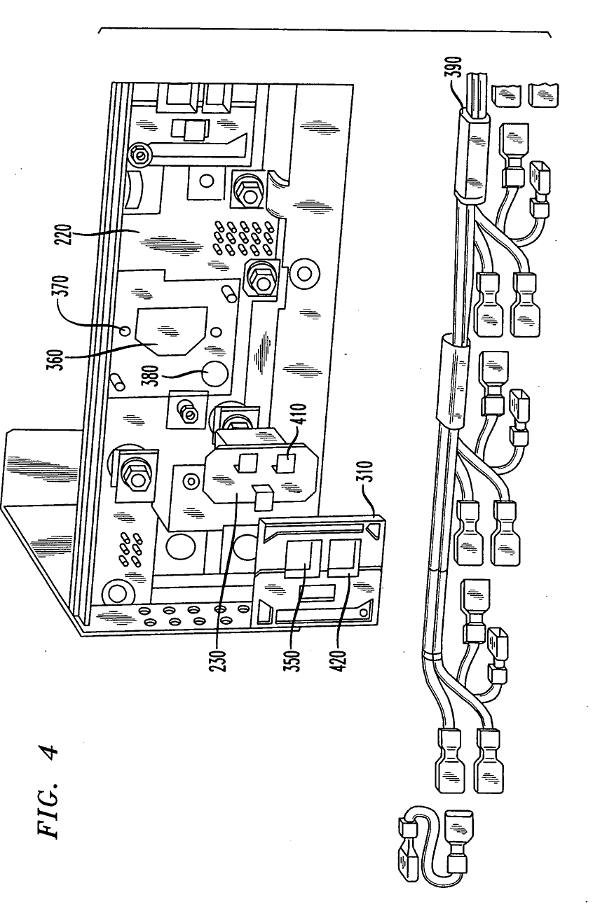

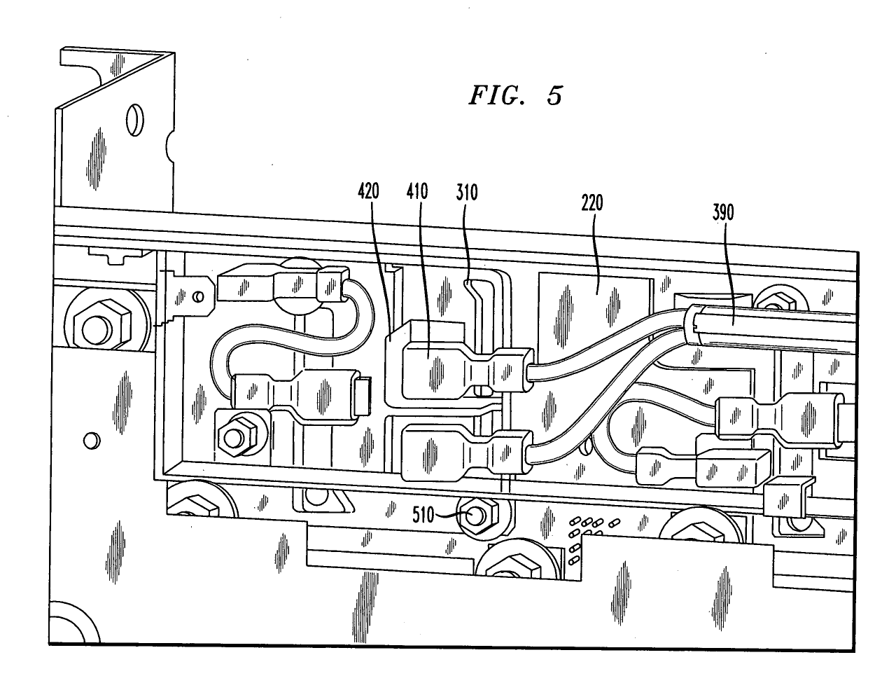

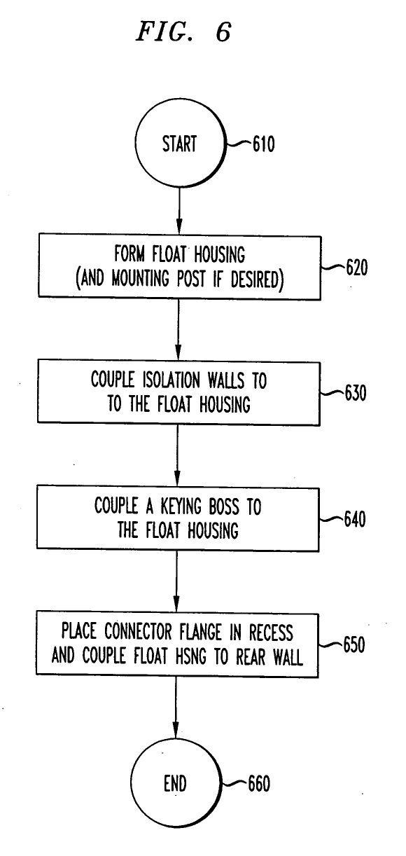

The float housing 310 further has terminal apertures (one of which is designated 350) therethrough. The terminal apertures 350 are configured to allow external access to terminals of the standards-based power connector 230 in a manner that will be shown more completely in FIGS. 4 and 5.

FIG. 3 also shows more detail concerning the rear wall 210. A power connector aperture 360 is configured to receive the standards-based power connector 230 and allow it to protrude into its respective bay. Mounting apertures 370 receive the mounting posts 330, providing them support at ends distal to the float housing 310. A keying boss aperture 380 is configured to receive the keying boss 240 and allow it to protrude into its respective bay.

Turning now to FIG. 4, illustrated is a reverse-angle, exploded, isometric view of the power converter shelf of FIGS. 2 and 3. FIG. 4 is presented primarily for the purpose of showing that the standards-based power connector 230 has terminals 410, and that the terminals 410 have ends oriented substantially parallel to the rear wall 210. This reduces the overall depth of the backplane by allowing a wiring harness 390 to lie flat. The wiring harness 390 couples the standards-based power connector 230 to other power connectors in the backplane.

In the illustrated embodiment, the floating power connector mount further includes isolation walls 420 coupled to the float housing 310 between the terminal apertures 350. The isolation walls 420 reduce the likelihood that neighboring electrical terminals will come into inadvertent contact with each other, causing a short circuit or other undesirable behavior.

Turning now to FIG. 5, illustrated is an assembled, isometric view of the power converter shelf of FIGS. 2, 3 and 4. FIG. 5 particularly shows how the wiring harness 390 includes electrical contacts 392 that couple to the terminals 410 of the standards-based power connector 230, how the terminal apertures 350 allow external access to the terminals 410 of the power connector 320 for the purpose of coupling the wiring harness 390 thereto, how the isolation walls 420 isolate the terminals 410 from one another and how the float housing 310 is mounted by a pair of conventional fasteners 510 to the rear wall 210.

Although the present invention has been described in detail, those skilled in the art should understand that they can make various changes, substitutions and alterations herein without departing from the spirit and scope of the invention in its broadest form.

What is claimed is:

1. For use with a power converter shelf having a rear wall, a floating power connector mount, comprising:
a float housing having a recess therein configured to receive and capture a flange of a standards-based power connector between said float housing and said rear wall, said standards-based power connector enabled to move within said recess.

2. The floating power connector mount as recited in claim 1 wherein said standards-based power connector is an International Electrotechnical Commission (IEC) connector.

3. The floating power connector mount as recited in claim 1 further comprising a mounting post coupled to said float housing and configured in position to fit within a corresponding mounting hole of said standards-based power connector and in lateral dimension to enable said standards-based power connector to move within said recess.

4. The floating power connector mount as recited in claim 1 wherein a shape of said recess is similar to a shape of said flange, said recess being configured in lateral dimension to enable said standards-based power connector to move within said recess.

5. The floating power connector mount as recited in claim 1 wherein said terminals have ends oriented substantially parallel to said rear wall.

6. A power converter rack, comprising:
a cabinet;
a power converter shelf mountable within said cabinet, having a rear wall and divided into a plurality of bays; and
a floating power connector mount associated with at least one of said plurality of bays, said floating power connector mount including:
a float housing having a recess therein that receives and captures a flange of a standards-based power connector between said float housing and said rear wall, said standards-based power connector enabled to float within said recess.

7. The power converter rack as recited in claim 6 wherein said mounting post is a first mounting post, said floating power connector mount further comprising a second mounting post coupled to said float housing and configured in position to fit within a corresponding second mounting hole of said standards-based power connector and in lateral dimension to cooperate with said first mounting post to enable said standards-based power connector to move within said recess.

8. The power converter rack as recited in claim 6 wherein a shape of said recess is similar to a shape of said flange, said recess being configured in lateral dimension to enable said standards-based power connector to move within said recess.

9. The power converter rack as recited in claim 6 wherein said terminals have ends oriented substantially parallel to said rear wall.
